(19) United States
(12) Patent Application Publication
(10) Pub. No.: US 2018/0127129 A1
(43) Pub. Date: May 10, 2018

(54) Method and apparatus for dispensing a granular product

(71) Applicants: Gil Gold, Skokie, IL (US); Tamir Levy, Skokie, IL (US)

(72) Inventors: Gil Gold, Skokie, IL (US); Tamir Levy, Skokie, IL (US)

(21) Appl. No.: 15/664,422

(22) Filed: Jul. 31, 2017

Related U.S. Application Data
(63) Continuation of application No. 14/711,521, filed on May 13, 2015, now abandoned.
Application No. 14/711,521 is a continuation-in-part of application No. 13/470,652, filed on May 14, 2012, now abandoned.

(51) Int. Cl. B65B 37/08; G01F 11/24; B65D 83/06; G01F 11/00

(52) U.S. Cl. CPC B65B 37/08; G01F 11/24; G01F 11/003; B65D 83/06

(57) ABSTRACT

A dispensing apparatus adapted to dispense powered products, such as protein that tends to compact and stick together, from a storage container into a dispensing chute using a hard rotatable ball or other member that contains one or more elongated slots or cavities. The rotating ball fits tightly into a flexible dispensing cup with a flexible, but tight seal. The ball is rotated by shaft with a handle to load one of the cavities with product. The dispensing cup has one or more hand and finger like structures that extend into the storage container that, when the ball is rotated are caused to move laterally, vibrating and dislodging the powder to flow into one of the cavities. Then, when the ball is rotated 180 degrees, the product drops out of the cavity into the dispensing chute.

This is continuation of application Ser. No. 14/711,521 filed May 13, 2015 which was a continuation-in-part of application Ser. No. 13/470,652 filed May 14, 2012. Application Ser. Nos. 14/711,521 and 13/470,652 are hereby incorporated by reference in their entireties.

### BACKGROUND

### Field of the Invention

The present invention relates generally to systems for dispensing granular products and fine particle powders and more particularly to a method and apparatus for dispensing granular products and powders with precise and consistent portion control.

### Description of the Prior Art

It is known in the art to dispense large granular products like breakfast cereal or coffee beans using mechanical dispensers. Such dispensers can be found in hotels, motels, restaurants and grocery stores as well as homes. Examples of such dispensers are taught in U.S. Pat. Nos. 7,703,639 and 6,964,355. These devices use either paddles or an impeller which, upon rotation, moves an amount of cereal or other product from a product storage area to a dispensing chute. Upon approaching the device, a user simply places a dish or bowl or bag under the chute and turns a handle attached to the paddles or impeller. A portion of the product then falls into the dish or bag. If the user wants more product, the handle is turned again, with little or no concern for precise portion control.

While very effective for dispensing breakfast cereals and other large products like coffees beans, cookie pieces, or whole walnuts, these inventions have problems dispensing fine products like ice cream toppings, peanuts, bulk spices, and candy in that they have a tendency to crush or break some of the product, or to stick or jam the mechanism. This also can cause some of the product to dispense in an undesirable broken form, to smear on the surfaces, or result in the dispenser jamming so tightly that it will not function. For example, ice cream sprinkles break very easily and are very difficult to mechanically dispense in repeatedly accurate quantities. Powder products, namely those with very fine particles, have the additional problem of sticking and clumping together which prevents the product from flowing. Examples of such powders are whey and soy protein powder, finely ground coffee, cosmetic powder and pharmaceuticals.

Dispensers of the prior art also have a quite large tolerance in the amount of product dispensed from turn to turn of the handle. One turn may dispense a much smaller amount of product than a subsequent turn. This is generally not a problem with breakfast cereal, since the user usually makes multiple turns to fill the bowl to the desired level. However, when an ice cream topping or the like is being dispensed, a much more precise control of the amount being dispensed from turn to turn is highly desirable, since the user will usually only make one or two turns. Tight control of dispensing quantity can result in greater sanitation and a huge cost savings in many operations.

Another disadvantage of prior art dispensers is that they are generally designed to dispense only one type of product (breakfast cereal for example). A different device must be used with a different product.

Thus, the four major problems with prior art dispensers are: 1) the inability to dispense a wide range of different sized products from the same dispenser, 2) the tendency for the dispenser to crush, break or smear fine products, or to jam when dispensing finer-grained products, 3) the inability of prior art dispensers to repeatably dispense accurate portions, especially of fine products, and 4) the tendency of fine-grained product to lump together preventing free flow and leakage.

It would be extremely advantageous to have a dispenser for granular products that could dispense soft, easily crushed products without damaging them and dispense an accurate fixed amount of product on each turn. It would also be advantageous to have a dispenser with interchangeable parts like different dispensing wheels that would allow the same dispenser to be used with a variety of different products.

Fine powders such as whey and soy proteins cause additional problems in dispensing since the particles have a tendency to stick together. Such fine powders stick together in upper part of a dispenser and will not flow or descend to be dispensed. It would be advantageous to have a system and method to efficiently dispense fine powders.

### SUMMARY OF THE INVENTION

The present invention relates to a method and apparatus with interchangeable parts for dispensing a wide variety of granular products in accurate repeatable portions without crushing or breaking of smaller products, and without smearing and jamming of the mechanism. A variety of rotating paddle wheels of different shapes and number of paddles for larger products can be interchanged with different ball/cup mechanisms for fine products. An optional removable detent can be used to provide a control stop rotation though particular angles to more precisely control portion size with any of the combinations. The ball/cup arrangement also helps prevent smearing and jamming.

The invention allows an efficient solution to the problem of dispensing products, especially food products, of many different sizes with a device that can be easily disassembled and cleaned, and modified to allow for repeatedly accurate dispensing of fine-grained products. Because the dispenser is closed, and it is not necessary to touch the product to dispense it or to insert a spoon or other utensil into the product, the present invention leads to a very hygienic and convenient way to dispense granular food products.

For soft or fine-grained products, the rotatable or rotating member is generally a ball or cylinder and has a smooth surface containing one or more cavities. A flexible dispensing cup made from a material like silicon rubber receives the smooth surface of the rotatable member forming a product seal, but allowing the rotatable member to rotate smoothly. The dispensing cup also can be connected to, or contain a dispensing chute or orifice. In a first position of the shaft, the cavity fills with the small granular product from a product storage container, and in a later position dispenses the product into the chute or dispensing orifice. In the preferred embodiment, the rotatable member for soft products is spherical containing a cavity that is approximately elliptical-shaped. The cavity may be sized to precise dispensing specifications.

A particular embodiment of the present invention directed at fine powders like proteins includes a flexible structure with one or more flexible fingers that extend upward from the rotating member into the mass of powder. The structure analogous to the shape of a human hand has fingers arranged so that when the rotating member rotates, it engages the bottom of the hand causing it to deform and to move laterally in the powder, the resultant vibration moves upward to the fingers and acts to dislodge the powder so that it fills the cavity in the rotating member. This prevents fine powders from clogging in the device, facilitating even flow of the product and precise dispensing from the cup and chute.

The rotatable member and cup can be changed to a choice of different sized detent mechanisms for precise measurement of quantities of product. The number and sizes of the detent balls can be chosen for the product to be dispensed and for the dispensing a precise amount and prevent waste or loss of product. For dispensing powders, the removable cup contains a flexible hand shaped structure in the center of the cup to vibrate when engaged by lip of the rotating member thereby loosening the powder and promoting even flow to the dispensing mechanism.

### DESCRIPTION OF THE FIGURES

Attention is now directed to several drawings that illustrate features of the present invention:

FIG. 1 shows a side view of an embodiment of the product dispenser of the present invention used for finer grained products.

FIG. 2 shows an exploded view the embodiment of FIG. 1.

FIG. 3 shows an embodiment of a precision dispenser for fine products according to the present invention.

FIG. 4 shows the embodiment of FIG. 3 from a different angle.

FIGS. 5A-5C show details of an optional detent mechanism suitable for use with many different embodiments of the present invention.

FIGS. 6A-6C show details of a spherical embodiment of a precision dispensing mechanism according to the present invention.

FIG. 7A-7B show an elliptical embodiment of the precision dispensing mechanism.

FIGS. 8A-8B show a cylindrical embodiment of the precision dispensing mechanism with an elliptical cavity.

FIGS. 9A-9B show a cylindrical embodiment of the precision dispensing mechanism with an elongated cavity that runs the length of the cylinder.

FIGS. 10A-10C show a set of interchangeable paddle members that can be used with granular products of different sizes.

FIGS. 11A-11C show side views of some of the paddle members of FIGS. 10A-10C.

FIGS. 12A-12B show a modified handle and shaft with a different fastener clip.

FIGS. 13A-13C show three different perspective views of an embodiment of the present invention directed toward fine powders like proteins and flour.

FIGS. 14A-14C show cut-away views of the embodiment of FIGS. 13A-13C with the slot in the rotating member up.

FIGS. 15A-15C show the same cut-away views as FIGS. 14A-14C with the slot turned.

FIG. 16 shows a straight-on cut-away view of an entire assembly with the slot in the rotating member facing up.

FIG. 17 shows the assembly of FIG. 16 with the rotating member turned ninety degrees.

Several drawings and illustrations have been presented to aid in understanding the present invention. The scope of the present invention is not limited to what is shown in the figures.

### DESCRIPTION OF THE PREFERRED EMBODIMENT

The present invention relates to a method and apparatus for dispensing an accurate predetermined amount of a granular product by turning a handle. The product is dispensed in a precise repeatable portion without crushing, breaking, smearing or leaking. The dispenser has optionally interchangeable parts for different sized products and different portions. Small grained products can include ice cream toppings such as sprinkles, crushed and chopped nuts, chocolate flakes, small candy as well as any other product such as crushed seeds, bulk spices, sugar and the like. From small grain products, such as sugar granules, to larger sized round candies, such as those sold under the name (M&Ms)™ by Mars, Inc., can be dispensed using a spherical, or other shaped, ball with cavities that fits into a mating flexible cup. Fine grain products such as whey or soy protein powder present an additional challenge because of their tendency to compact and stick together preventing the product to flow through the container, and thus require additional functional elements to accommodate those materials. Traditionally larger products like breakfast cereal and whole nuts can be dispensed with the same device by simply removing the ball and cup and replacing them a rotating member with various sized paddle wheels. In this way, the same dispenser can be used with many different products of different granular sizes and shapes.

An interchangeable dispenser part can thus be made to dispense a particular amount of a product in certain size sub-ranges. For example, a particular dispenser might be optimized to dispense a predetermined amount of ice cream topping, while another dispenser might be optimized to dispense a different amount of a different product, or a product in a different size sub-range side by side on the same stand or base.

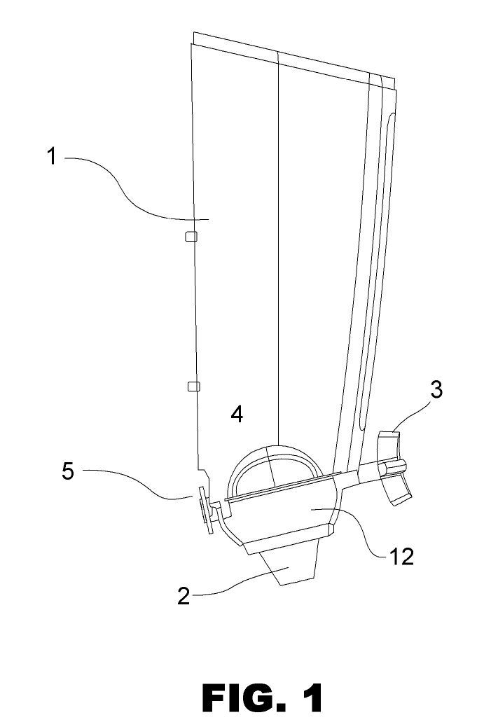

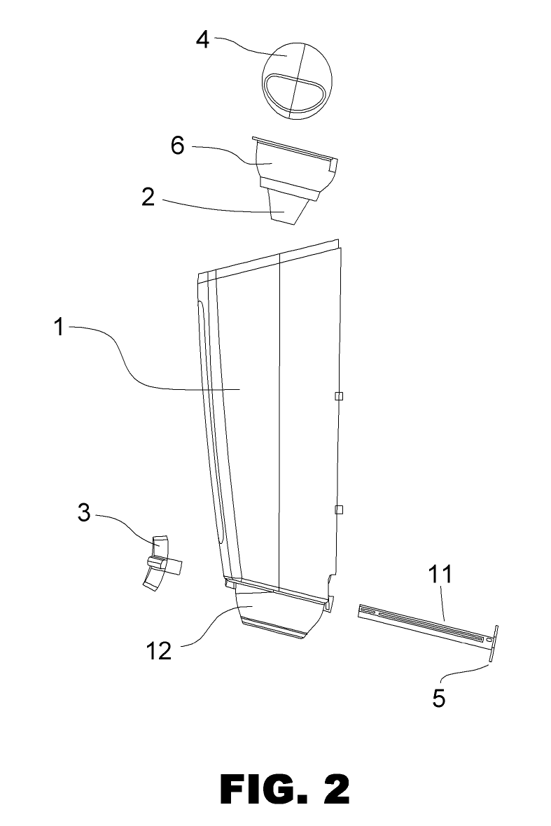

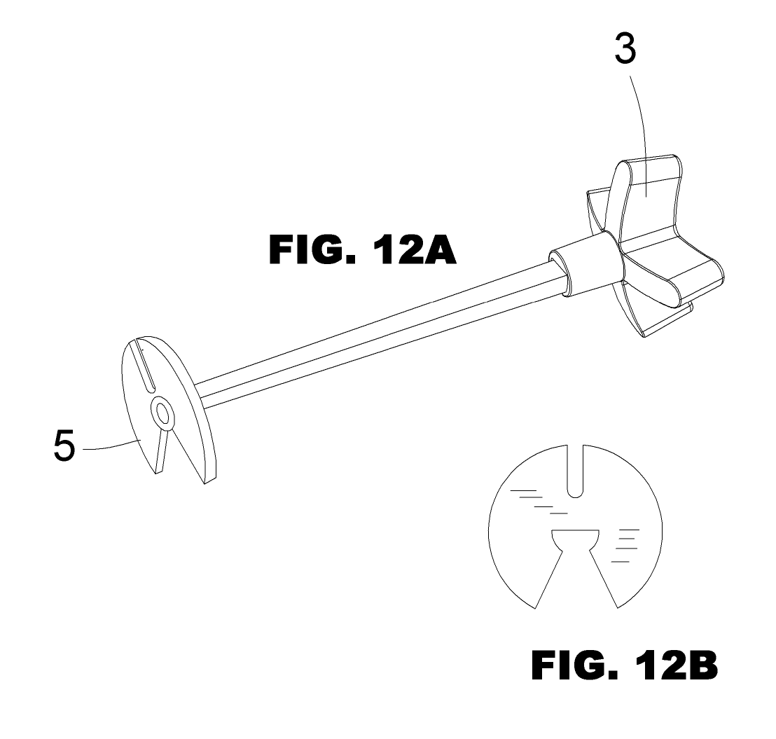

FIG. 1 shows a side view of an embodiment of the present invention for fine products that uses a dispensing ball and cup. FIG. 2 shows this embodiment broken apart. In FIGS. 1-2, it can be seen that a product container 1, usually clear plastic, is mounted on a base 12 containing a chute 2. A rotatable, precision dispenser ball (or other shape) 4, usually with a hard smooth surface, mates with a flexible cup 6 and can be rotated by a removable handle 3. Typically, a lip 25 circles the top of the flexible cup 6 to form a seal between the cup and the rotatable member. An optional detent 5 locks the rotation and causes the device to click or snap through a series of fixed angular positions as the handle 4 is turned. A particular choice of fixed angular positions might be, for example, three clicks to make a quarter turn. Any number of clicks per turn is within the scope of the present invention. FIG. 12 shows the handle affixed to the shaft and a retaining shaft clip.

The rigid product container 1, which can also be optimized for fine grain product may have a rigid cup area 12 that can be part of the product container 1 that mates to a removable flexible cup 6 with a chute 2 that extends through the bottom of the rigid cup area 12. This chute 2 can be a continuous part of the flexible cup 6 and made of the same material, or it can be separately attached to the flexible cup 6 and made of the same or different material. A dispensing ball 4 or other rotatable part fits into the flexible cup 6 and is turned by a shaft 11 that passes through it. [The handle 3 attaches to one end of the shaft 11, and part of the optional detent mechanism 5 attaches to the other end.] Thus, when the handle 3 and shaft 11 are turned, the ball 4 rotates in the flexible cup 6. The shaft 11, while generally of cylindrical cross-section, typically has a flat surface that allows it to fit into a partially cylindrical hole in the ball 4. This shaft is removable and also mates into other dispensing members such as interchangeable paddle wheels for larger products and other types of clips as shown in FIGS. 12A-12B.

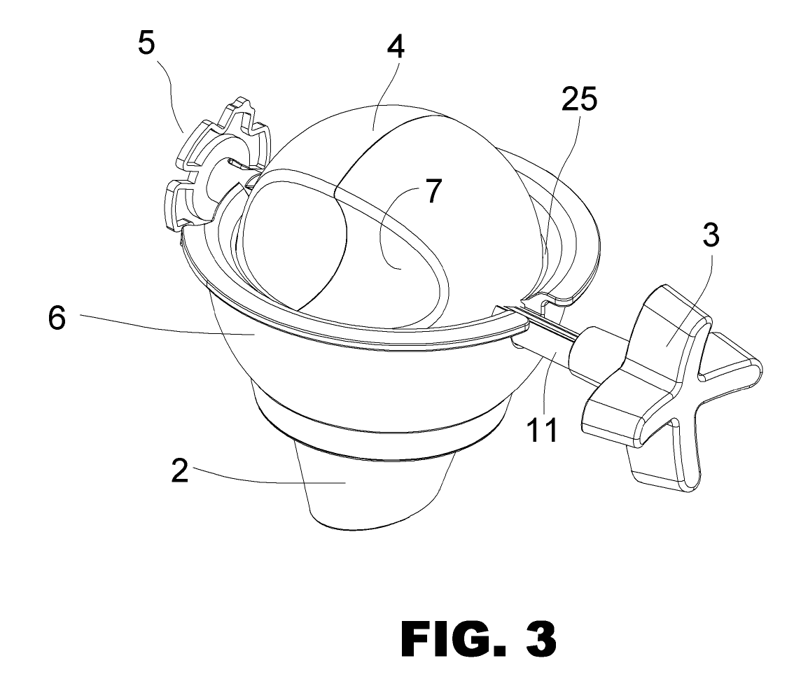

FIG. 3 shows a detail view of an embodiment of a precision dispensing mechanism for fine products. The rotatable part 4 mates in a flexible cup 6 forming a seal with the cup 6 being further sealed by the lip 25. The flexible cup 6 is typically made from a soft, flexible material such as food-grade silicon rubber known in the art.

The rotatable part 4 has been called a ball for convenience; however, it does not necessarily have to be spherical. In fact, it can be any shape as long as it can rotate in a mating cup 6. The shaft 11 passes through the ball 4 so that when the shaft 11 is rotated, the ball 4 also rotates. The handle 3 can be mounted on the front or the side of the device. Any method of causing the ball or paddle wheel to rotate with the shaft 11 is within the scope of the present invention. The shaft 11 is usually driven by the handle 3. Edges 5 of an optional detent mechanism can be mounted on the distal end of the shaft 11.

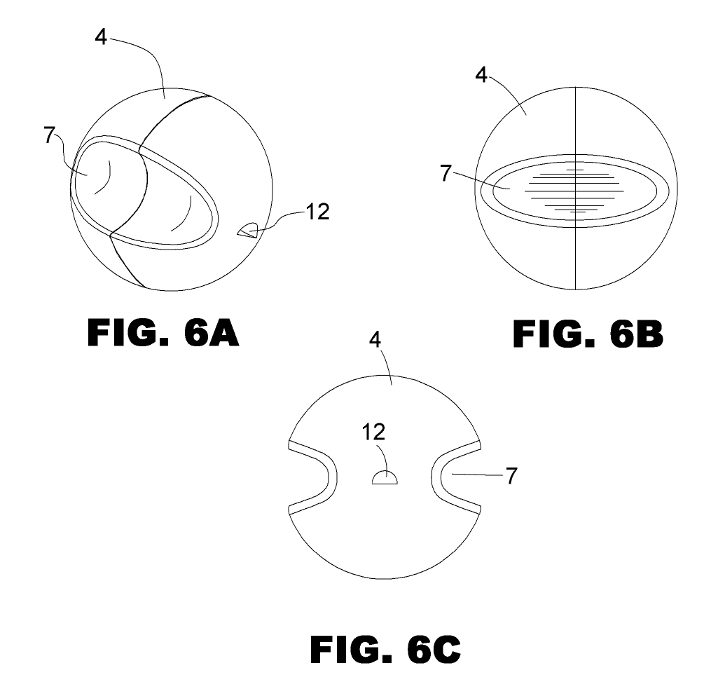

A particular feature of the rotatable member or ball 4 is that it contains a cavity 7, usually a smooth cavity, that can be sized to dispense a precise amount of a granular product. The cavity 7 can be any shape or depth; however, it is preferred that it have a smooth surface and contour so that the product slides out of it when it becomes aligned with the chute or dispensing orifice 2. A preferred cavity 7 for fine product is an elliptical cavity with a parabolic profile (shown more clearly in FIGS. 6A-6C. The present invention allows the use of many different size balls or rotatable members with many different size cavities. Any size or shape of rotatable member and any size or shape of cavity is within the scope of the present invention. In the non-use position, the cavity 7 faces upward into the product and typically fills with product (if the cavity ends up not facing upward after a use, it can be rotated until it does). As the handle 3 is then rotated, the ball 4 makes approximately a half revolution and delivers the contents of the cavity 7 into the chute or orifice 2 where it falls and is dispensed. The ball 4 can have two or more cavities 7 equally spaced around its periphery. A distinct advantage of the rotatable member or ball 4 of the present invention over the prior art is that the cavity 7 can be specifically sized for certain products or a particular product class and therefore dispense an exact and repeatable amount of the product on each subsequent turn. The repeatability is typically within a range of 2-12%.

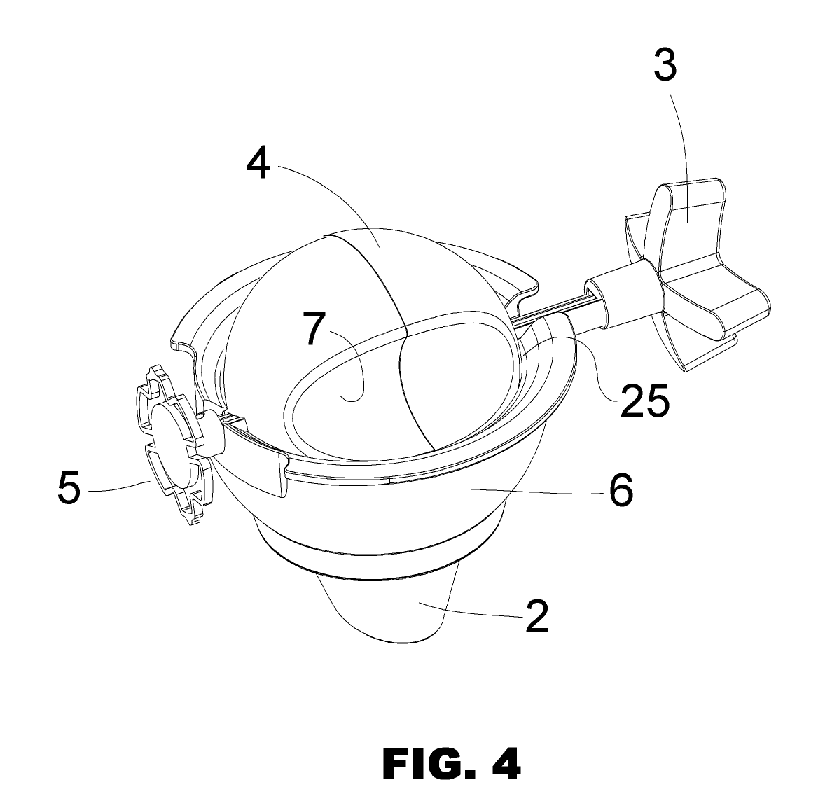

Another particular feature of this embodiment is the flexible cup 6 that mates with the smooth surface of the ball 4. This forms a seal with the optional lip 25 that prevents fine grain product from leaking out, but is soft and flexible so that the interface between the ball 4 and the cup 6 or the edges of the cavity 7 and the cup 6 will not crush or break the product nor cause smearing or jamming. The flexible cup 6 gives way just slightly under the pressure of excess product. This feature prevents crushing, breaking, jamming and leaking, and leads to smooth rotation of even very delicate product such as ice cream sprinkles. FIG. 4 shows the same embodiment as FIG. 3 but from a different viewing angle, containing the handle, shaft and alternate clip fastener.

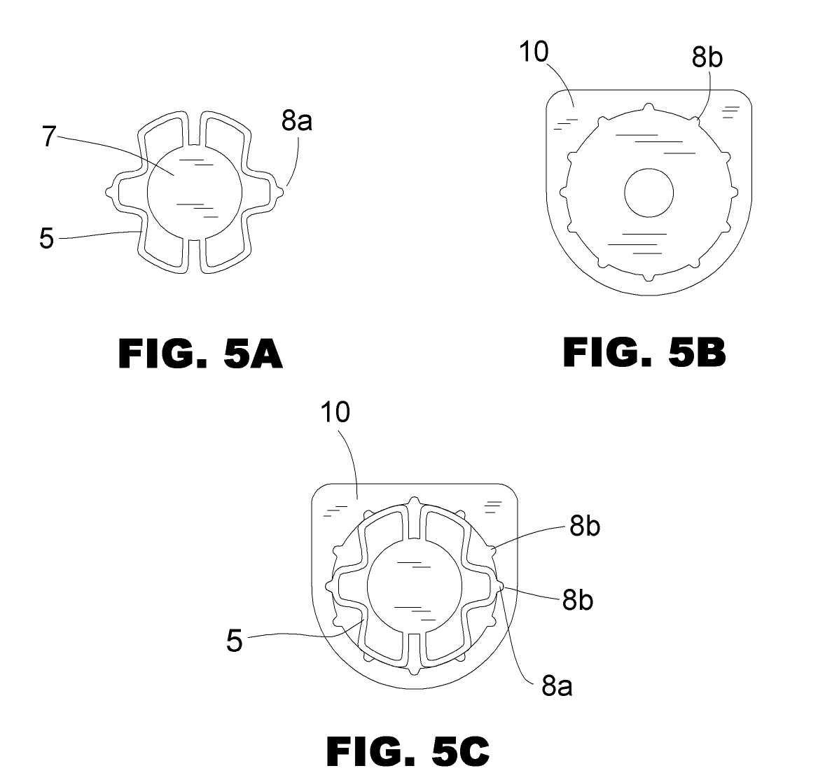

FIGS. 5A-5C show details of an embodiment of a detent mechanism that can be used with a variety of interchangeable rotatable members. FIG. 5A shows a rotatable part that mounts on the shaft 11. A center disk 7 holds a shaped edge 5 that contains several small protruding points 8a that form a spring. The mechanism can be made of plastic, metal or any other product that that will act as a spring. FIG. 5B shows a mating part 10 that is typically rigidly attached to the solid base or other part of the dispenser. It contains an indented, generally circular region with several grooves 8b around its periphery. FIG. 5C shows the shaft part from FIG. 5A inserted or mounted in the circular part from FIG. 5B. It can be seen that the protruding points 8a on the edges 5 of the rotatable part snap into the grooves 8b. The edge structure 5 of the rotatable part thus forms a spring that allows the entire mechanism 7 to be both normally locked and rotatable. The protrusions 8a release from one groove and click or snap into the next groove 8b as the device is rotated. While the embodiment shown in FIGS. 5A-5C has three snaps per quarter turn, any number of snaps or clicks per turn is within the scope of the present invention. This detent mechanism can be optional and can be made removable from the dispenser.

FIGS. 6A-6C show a detail of a spherical embodiment of the ball 4. A half-round hole 12 passes through the ball and receives the shaft 11. The cavity 7 is approximately elliptical when viewed face-on such as in FIG. 6B, but has an approximately parabolic or Gaussian (or similar) profile when viewed from the side such as in FIG. 6C. As previously stated, this cavity 7 can be sized to dispense a particular amount of a product class.

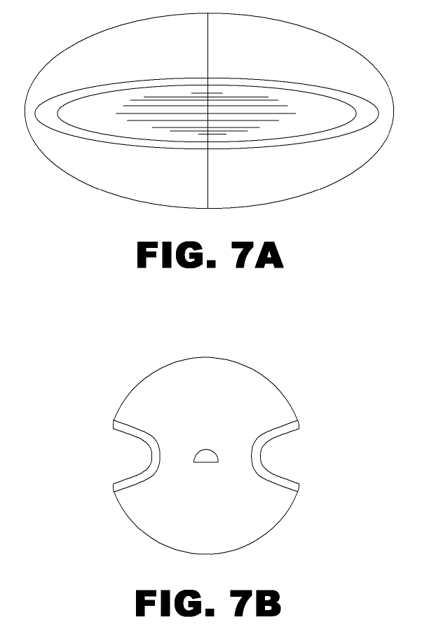

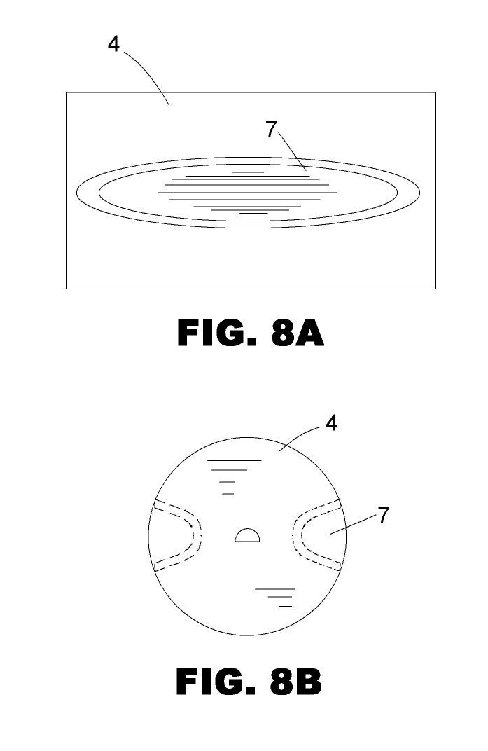

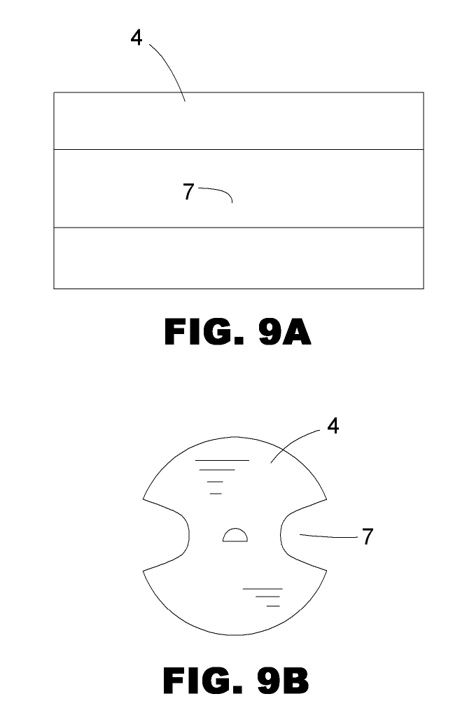

FIGS. 7A-7B show a rotatable part of ball 4 that is an ellipsoid of revolution. The cavity 7 is elliptically shaped facing head-on with a parabolic or Gaussian (or similar) profile when viewed from the end. FIGS. 8A-8B show a cylindrical rotatable part or ball 4 with a cavity 7 that is similar to the cavities previously shown and described. FIGS. 9A-9B show a cylindrical rotatable part or ball 4 with a continuous cavity 7 having a parabolic or Gaussian (or similar) profile that runs end-to-end. As has been previously stated, any size or shape of rotatable part or ball and any size and shape of cavity is within the scope of the present invention. Alternate embodiments may include balls with more than one cavity and balls with cavities of different shapes or profiles on the same ball.

While the rotatable ball type mechanism for fine grain product has been described as mating with a soft flexible cup to form a seal, other embodiments can use such a rotatable part with a rigid cup for particular products.

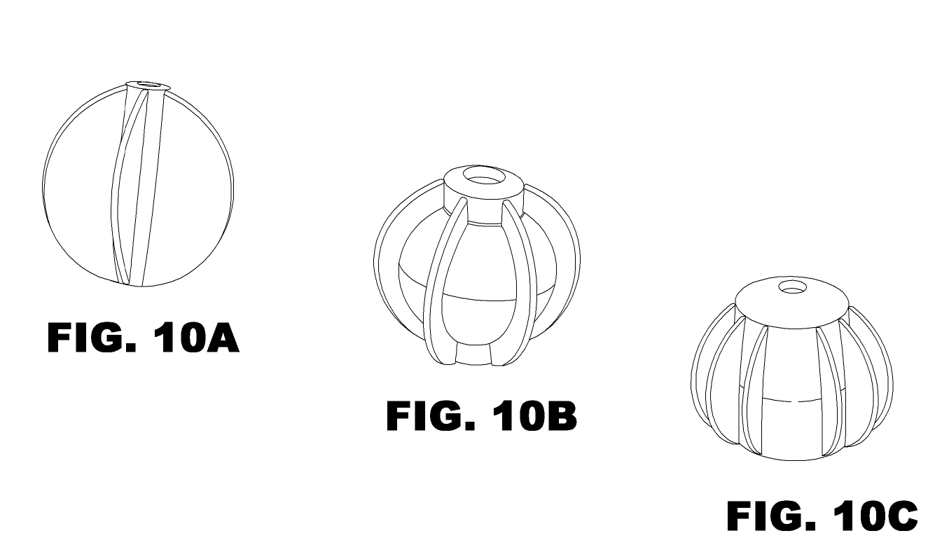

As previously discussed, the present invention can be built so that different rotatable members can be interchanged. In particular, paddle wheels can be interchanged with the rotatable ball/cup mechanism. This interchangeability allows a single dispenser to be used with large products like breakfast cereal, or large whole products and then by simply changing the rotatable member to a ball and cup, be used with small and fine grain products such as sprinkles or spices. FIGS. 10A-10C show several different paddle wheels that can be interchanged into the present invention. FIG. 10A shows a 4-blade paddle wheel; FIG. 10B shows a 6-blade paddle wheel, while FIG. 10C shows a 12-blade paddle wheel. The 4-blade wheel of FIG. 10A can be used for very large products and/or large portions. The wheels with more paddles can be used with smaller products and/or smaller portions. The paddles in any of the wheels shown in FIGS. 10A-10C can have different center shapes depending on the product to be dispensed and/or the portion desired. For example, the 4-blade wheel shown in FIG. 10A has a very small diameter cylinder for a center shape. The 6-blade wheel shown in FIG. 10B has a spherical center shape, while the 12-blade wheel shown in FIG. 100 has a cylindrical center shape larger than that of the wheel of FIG. 10A. Any combination of center shape and size and any number of paddle blades is within the scope of the present invention.

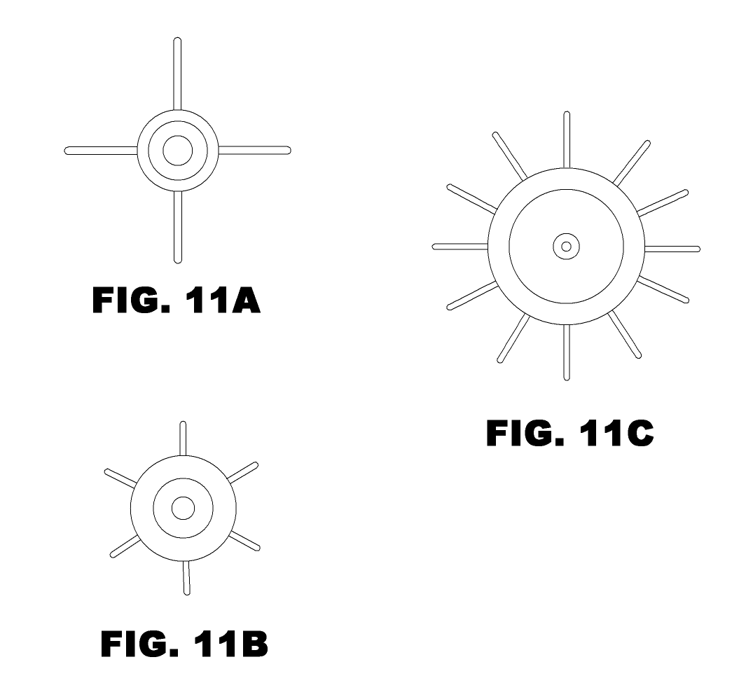

FIGS. 11A-11C show side views of some of the paddle wheels from FIG. 10. FIG. 11A shows a 4-paddle wheel; FIG. 11B shows a 6-paddle wheel, and FIG. 11C shows a 12-paddle wheel.

The present invention efficiently solves the problems found in prior art dispensers. By using interchangeable parts, it allows accurate dispensing of products of many different sizes and shapes. By using a rotatable member that mates with a soft flexible cup, it allows dispensing of fine, easily broken products without breakage or jamming, and it allows for dispensing very accurate, repeatable portions, especially of fine grain products.

FIGS. 12A-12B show a modified handle and fastener clip. This type of fastener clip can be keyed for a single revolution.

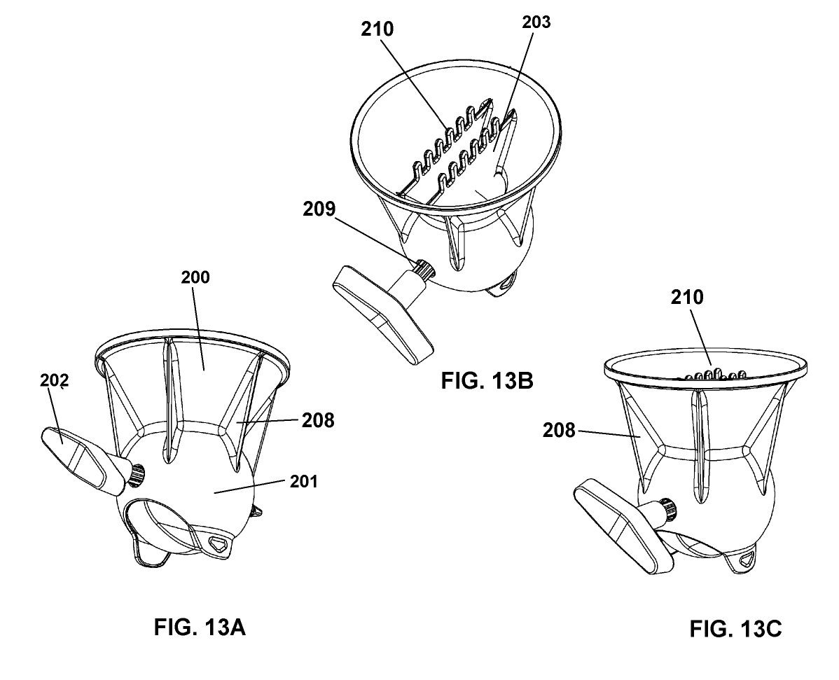

FIGS. 13A-13C show a different embodiment of the present invention. This embodiment is directed toward very fine powders like proteins and the like. Soft powders are particularly hard to dispense since they tend to compact and prevent consistent product flow. Without some sort of special additional feature, the soft powder simply clumps together and does not properly flow to fill the slot in the rotating ball.

The embodiment of FIGS. 13A-13C has a removable funnel chute 200 that connects to a powder container (not shown). A flexible, approximately spherical cavity 201 is adapted to hold a rotating member such as a spherical ball (not shown). A set of optional supports 208 strengthen the funnel chute 200 and make it stiffer so that it retains its shape. A handle 202 and shaft 209 pierce the spherical cavity 201. Looking down from the top in FIG. 13B, a pair of flexible structures 203 with fingers 210 can be seen. These structures 203 protrude up into the powder and are adapted to loosen it so that it flows in the funnel chute 200 and onto the rotating member. The entire assembly shown in FIGS. 13A-13C is made of a stiff, flexible material such as food-grade silicon rubber.

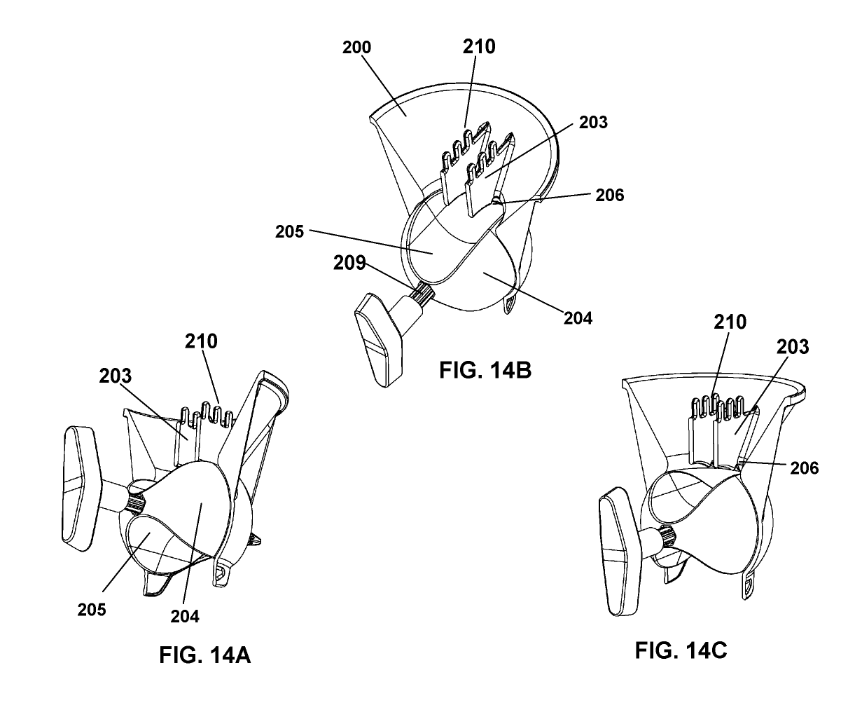

FIGS. 14A-14C show cut-away drawings of the assembly with the rotating member 204 inserted. In these figures, the slot 205 in the rotating member 204 is shown in the up position. In this position, the entire bottom end of the hand 203 and fingers 210 sit above the slot or cavity 205 in the rotating member 204. Each hand 203 with fingers 210 has an edge 206 that protrudes downward just slightly into the slot 205 where it can be engaged by the edge of the slot in the rotating member 204 as the ball passes by the mechanism.

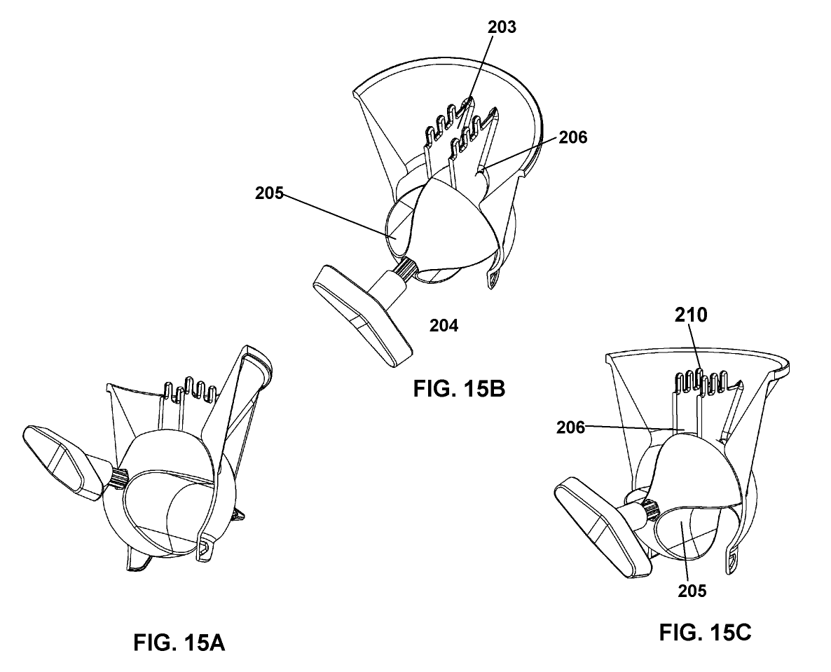

FIGS. 15A-15C show the same assembly as FIGS. 14A-14C except that the rotating member 204 has been rotated so that the slot 205 is no longer straight up. The lower edge 206 of the hand 203 and fingers 210 is pushed laterally as the edge of the ball and slot 205 passes by. This causes the entire hand 203 and each of the fingers 210 to move laterally in the powder thereby loosening it and moving it so that it flows cleanly into the slot 205. As with previous embodiments of the invention, when the filled slot 205 rotates to a 180 degree position, its load of powder is dumped downward into a dispensing chute.

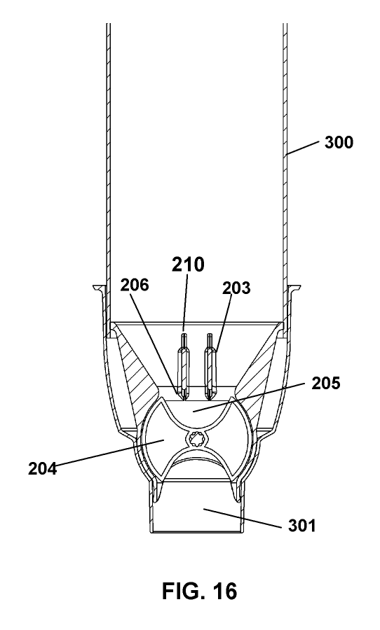

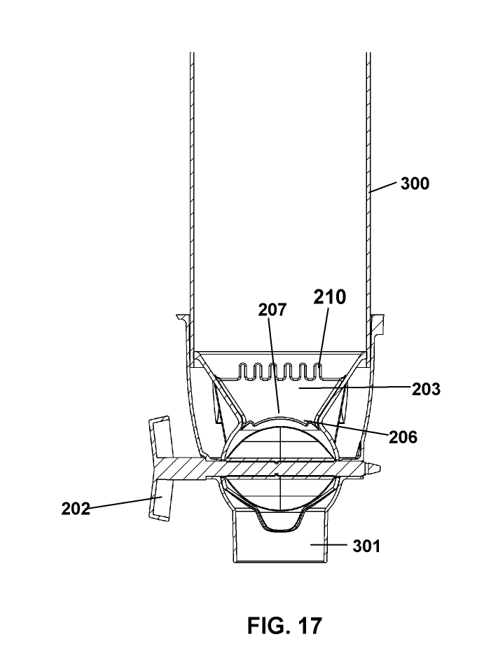

FIGS. 16-17 show a sectional view of the embodiment discussed in FIGS. 13A-13C, 14A-14C and 15A-15C. Here, the product container 300 and the dispensing chute 301 can also be seen. FIG. 16 shows an end view of the hand 203 and fingers 210. The edge 206 can be seen extending just slightly into the cavity 205 in the ball 204. FIG. 17 shows a side view of the hand 203 and fingers 210. Here it can be seen that the left and right outside edges 206 of the bottom of the hand and fingers extend downward into the ball cavity like tiny tabs. The center of the bottom 207 of the hand 203 smoothly mates with the surface of the ball.

As with previous embodiments of the present invention, the embodiment shown in FIGS. 13-15 and part of FIGS. 16-17 uses food grade silicon rubber as a preferred material for the chute 200 and cavity 201. The rotating member 201 can be made from hard smooth plastic or other hard, rigid material, while the shaft 209 can be metal. The hand 203 and fingers 210 can also be made from food grade silicon rubber, or alternatively, they can be plastic.

Several descriptions and illustrations have been presented to aid in understanding the present invention. One with skill in the art will realize that numerous changes and variations are possible without departing from the spirit of the invention. Each of these changes and variations is within the scope of the present invention.

We claim:

1. A dispenser constructed to dispense a predetermined amount of a powdered product from a storage container into a dispensing chute, the dispenser comprising:
a removable powder product storage container in communication with a dispensing mechanism;
said dispensing mechanism including:
(a) a rotatable spherical ball attached to a shaft, the rotatable spherical ball having a smooth surface, wherein said smooth surface contains two cavities opposed to one-another by 180 degrees, each of the cavities constructed to contain the predetermined amount of the powered product;
(b) a flexible dispensing cup attachable to the product storage container having an upper funnel part and a lower spherical part that forms a flexible spherical cavity constructed to receive the rotatable spherical ball, the spherical ball rotatable in the flexible spherical cavity by the shaft that penetrates the spherical ball, the flexible dispensing cup having a sealing lip that fits circumferencially around the spherical ball forming a powder-tight seal;
(c) two flat parallel hand and finger members attached to the flexible dispensing cup, each finger member having a top end and a bottom end, the top ends extending vertically from the flexible dispensing cup away from the spherical ball and into the powdered product storage container; the bottom ends extending into one of the cavities in the spherical ball when the spherical ball is in a position with one of its cavities facing substantially upward, the two parallel hand and finger members configured to move laterally when said one of the cavities in the spherical ball moves to a position wherein said cavity is not substantially upward;
and, wherein, the hand and finger members are constructed to displace from a vertical position to loosen the powdered product in the storage container causing the powdered product to flow into one of the cavities in the spherical ball for dispensing into the dispensing shoot when the spherical ball is rotated 180 degrees.

2. The dispenser of claim 1 wherein the flexible dispensing cup is food-grade silicon rubber.

3. The dispenser of claim 1 wherein the shaft is terminated in a detent mechanism on a distal end.

4. The dispenser of claim 1 wherein the shaft is terminated with a handle on a proximal end.

5. The dispenser of claim 1 wherein the shaft is affixed to a handle and secured on the distal end by a retaining clip.

6. The dispenser of claim 1 wherein the cavities in the spherical ball have an approximately parabolic or Gaussian cross-section.

7. The dispenser of claim 6 wherein the cavities in the spherical ball have an approximately parabolic cross-section.

8. The dispenser of claim 1 further comprising a plurality of notches on the upper end of each hand and finger member.

9. A dispenser constructed to dispense a predetermined amount of a powdered product from a storage container into a dispensing chute, the dispenser comprising:
a removable powder product storage container in communication with a dispensing mechanism;
said dispensing mechanism including:
(a) a solid, rotatable member attached to a rotatable shaft, the rotatable member having a smooth surface, wherein said smooth surface contains two cavities opposed to one-another by 180 degrees, each of the cavities constructed to contain the predetermined amount of the powered product;
(b) a flexible dispensing cup attachable to the product storage container having an upper funnel part and a lower part that forms a flexible cavity constructed to receive the solid rotatable member, the rotatable member being rotatable in the flexible cavity by a shaft that penetrates the rotatable member, the flexible dispensing cup having a sealing lip that fits around the rotatable member;
(c) two flat parallel hand and finger members attached to the flexible dispensing cup, each finger member having a top end and bottom end, the top ends extending vertically from the flexible dispensing cup away from the rotatable member and into the powdered product storage container; the bottom ends extending into one of the cavities in the rotatable member when the rotatable member is in a position wherein one of the cavities in the rotatable member is substantially upward; the two parallel hand and finger members being configured to move laterally when said one of the cavities in the rotatable member moves to a position wherein said cavity is not substantially upward;
wherein, the hand and finger members are constructed to displace and to loosen the powdered product in the storage container causing the powdered product to flow into one of the cavities in the rotatable member for dispensing into the dispensing shoot when the spherical ball is rotated 180 degrees.

10. The dispenser of claim 9 wherein the flexible dispensing cup is food-grade silicon rubber.

11. The dispenser of claim 9 wherein the rotatable shaft is terminated in a detent mechanism on a distal end.

12. The dispenser of claim 9 wherein said rotatable shaft is terminated with a handle on a proximal end.

13. The dispenser of claim 9 wherein the rotatable shaft is affixed to a handle and secured on the distal end by a retaining clip.

14. The dispenser of claim 9 wherein the cavities in the rotatable member have an approximately parabolic or Gaussian cross-section.

15. The dispenser of claim 14 wherein the cavities in the rotatable member have an approximately parabolic cross-section.

16. The dispenser of claim 9 further comprising a plurality of notches on the upper end of each hand and finger member.

17. The dispenser of claim 9 wherein the rotatable member is a sphere.

18. The dispenser of claim 9 wherein the rotatable member is a cylinder.
